(19) United States
(12) Patent Application Publication
(10) Pub. No.: US 2006/0255961 A1
(43) Pub. Date: Nov. 16, 2006

(54) Radio control device for issuing commands to a remote controlled apparatus

(75) Inventors: Jurgen Hofer, Wien (AT); Thomas Jatschka, Kleinengersdorf (AU); Dr. Alfred Pohl, Mistelbach (AU); Robert Tschofen, Wien (AU)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 10/561,683

(22) PCT Filed: Mar. 25, 2004
(86) PCT No.: PCT/EP04/03179

§ 371 Date: Jun. 19, 2006

(30) Foreign Application Priority Data
Jun. 25, 2003 (DE) 103 28 590.3

(51) Int. Cl. G05B 19/02

(52) U.S. Cl. 340/825.22; 340/5.8; 340/825.52; 340/825.69

(57) ABSTRACT

Disclosed is a radio control device which is used for issuing commands in a wireless manner to a remote controlled apparatus and in which an allocation mode can be run before said radio control device is operated. The inventive radio control device comprises a transmitter/receiver unit, a control mechanism, and at least one antenna. Once the user has triggered the allocation mode, the radio range of the remote control device is lowered such that communication can be established only with an apparatus that is located in the immediate vicinity of the remote control device and returning to the standard range is possible only once the allocation process has been completed.

### CROSS REFERENCE TO RELATED APPLICATIONS

This application claims priority to the German application No. 10328590.3, filed Jun. 25, 2003 and to the International Application No. PCT/EP2004/003179, filed Mar. 25, 2004 which are incorporated by reference herein in their entirety.

### FIELD OF INVENTION

The invention relates to a radio remote control for issuing commands to a remotely controllable device in a wireless manner, said radio remote control allowing execution of an assignment mode before becoming operational, including a transmit/receive unit, a controller and at least one antenna, wherein after the assignment mode is triggered by the user, the radio range of the remote control is decreased so far that communication is only possible with a device which is immediately adjacent to the remote control, and a return to the standard range only takes place after assignment is complete.

### BACKGROUND OF INVENTION

Particularly stringent safety requirements are necessary in the case of remote controls or remote controllers, particularly for industrial or agricultural devices. The remote controls normally use a conventional radio standard, e.g. Bluetooth, wherein ranges up to 100 m are usual depending on the performance class.

In order to prevent unintentional assignment of a “wrong” device to a remote control during the assignment or reassignment, the prior art requires at least the input of a PIN code at the remote control in order to start the assignment or identification procedure. In the case of Bluetooth, this is described in “LMP Lager Tutorial”, 3.1.2 Authentication, 3.1.3 Pairing (freely available on the www at http://203.147.194.107/infotooth/tutorial/lmp.asp), for example.

The input of a PIN code requires the presence of a (alpha)numeric keypad at the remote control. This requirement is contrary to the wish for simple operation via a keypad displaying as few symbols as possible, often only generally understandable symbols such as ↑ and ↓. However, if the triggering of the assignment mode is simplified, e.g. by omitting a PIN, there is an increased danger that a device which is situated within radio range is inadvertently assigned and subsequently started.

U.S. Pat. No. 6,369,693 B1 shows a radio remote control of the type cited at the beginning, said radio remote control having a memory for storing protected data such as an identification code of the remote control, for example. A device can be assigned to the radio remote control on the basis of this code. Furthermore, the radio remote control can transmit control commands using a first power level to a device, e.g. a door lock of a vehicle or a TV device, and can also transfer the protected data using a second lower power level to the device.

WO 98/02860 shows an arrangement and a method for establishing a communication pair consisting of a transmitter and a receiver, wherein only a receiver which is physically arranged such that it is directly adjacent to the transmitter can communicate for the purposes of assigning a transmitter to a receiver.

The solutions disclosed in U.S. Pat. No. 6,369,693 B1 and WO 98/02860 are disadvantageous primarily in that a user cannot be sure whether the assignment of the remote control to a specific device has been carried out successfully.

### SUMMARY OF INVENTION

The invention addresses the problem of providing a radio remote control which allows reliable assignment to a device and is as simple as possible to operate.

In accordance with the invention, this problem is solved by optically and/or acoustically indicating the start of the assignment mode and/or its successful completion.

The solution according to the invention is characterized in that it is particularly simple and is optimally adapted to the actual conditions in industry and agriculture. The assignment process can be triggered by pressing a single key, for example, whereupon the assignment takes place e.g. on a remote control which is immediately adjacent to the device.

In practice, it is particularly advantageous if the radio range is decreased by reducing the transmission power. This also offers very high protection against unwanted “interception” of the transmitted signal.

Alternatively or additionally, it is also possible to decrease the radio range by reducing the receiver sensitivity, or to decrease the radio range by intervening in the antenna function.

In the interest of clear and simple operation, it may be appropriate optically and/or acoustically to indicate the start of the assignment mode and/or its successful completion.

### BRIEF DESCRIPTION OF THE DRAWINGS

The invention and further advantages are explained in greater detail below with reference to exemplary embodiments which are illustrated in the drawing and in which:

FIG. 1 shows a schematic side view of a device, e.g. a mobile loading crane, with docked-on remote control;

FIG. 2 shows a schematic illustration of the docking point from FIG. 1, enlarged and sectioned;

FIG. 3 shows the schematic circuit for information transfer in the initialization mode in a possible embodiment;

FIG. 4 shows a possible initialization routine in a flow diagram.

### DETAILED DESCRIPTION OF INVENTION

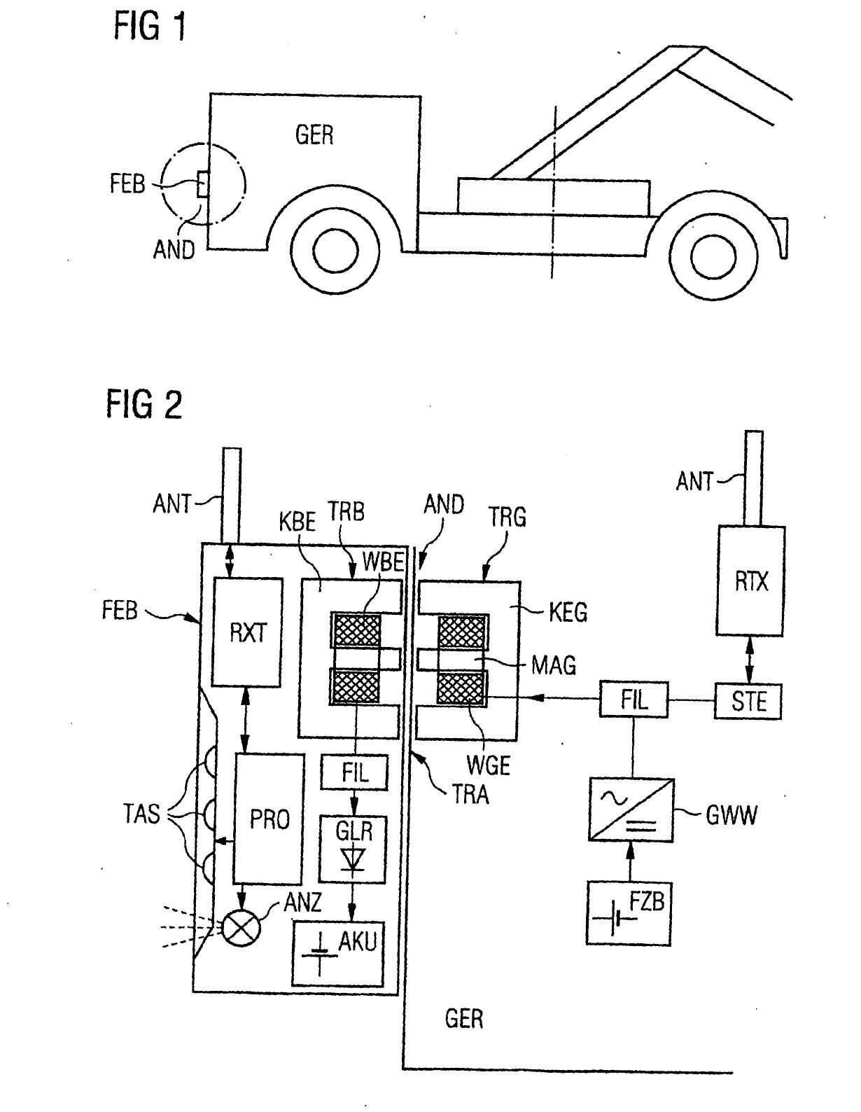

FIG. 1 shows a device GER, e.g. a mobile loading crane, a common industrial or agricultural device which can be wirelessly operated by means of a remote control. Such a remote control FEB, which can be held in the hand by an operator, is temporarily fixed to a docking point AND of the device GER in accordance with FIG. 1, either merely mechanically with the aid of a suitable mounting, or by means of a magnetic mounting which is explained below.

FIG. 2 shows further details in the sectional illustration which is significantly enlarged relative to FIG. 1. The device GER includes a transformer half TRG which has a core KEG, a cup-type core in this case, and a coil WGE or winding. The core KEG contains a permanent magnet MAG, which forms the central core part of the core KEG. In variants, the magnet can be arranged at other positions, wherein it is always essential that said magnet performs its retaining function for the remote control FEB.

In a quasi mirror image, a second control-oriented transformer half TRB is arranged in the remote control FEB and likewise has a core KBE and a winding or coil WBE. The “open” sides of the two transformer halves TRB, TRG are arranged directly at an external wall of the housing of the remote control or the device GER respectively, and are only covered by the relevant device wall which consists of plastic or a non-magnetizable metal.

It is immediately evident from FIG. 2 that the remote control FEB can be temporarily attached to the device GER in the illustrated manner, since the two cores or core halves KEB, KEG attract each other due to the permanent magnet MAG which is contained in the magnetic core of said device.

At this point, it should be noted that the core KBE in the remote control FEB can also include a permanent magnet whose polarity can be selected in certain remote controls such that, interacting with certain devices at the docking point which can be marked accordingly, there is not an attraction but a repulsion. Pairings of remote controls and devices can therefore be shown to be prohibited from the outset.

The docking point AND serves as an inductive energy interface, at which charging energy can be supplied from the device GER to an accumulator AKU of the remote control FEB as explained below.

A power source, e.g. a vehicle battery with a voltage of 24 or 48 volts, is located in the device GER. This battery voltage is converted into an alternating voltage by means of a direct voltage/alternating voltage converter GWW and is supplied as such to the coil WEG. If provision is made for converting to an alternating voltage at 50 Hz, the remote control FEB will be compatible with simple mains-supplied charging devices.

Although this is not shown, it is obvious to a person skilled in the art that the converter GWW is not activated, e.g. with the aid of a contactless switch such as a reed contact, until the remote control is docked.

The alternating voltage which is induced in the secondary coil WBE of the transformer TRA is rectified by means of a rectifier GLR and supplied to the accumulator AKU in order to charge it. Suitable charging and regulating circuits, which are known to a person skilled in the art, can be used as a matter of course depending on the type of the accumulator. A display of the charging status and charging process can likewise take place.

The remote control FEB has a transmit/receive unit RTX which interacts with an antenna ANT. Provision is further made for a controller PRO, e.g. a microprocessor, which can also be part of the transmit/receive unit RTX. Keys TAS of a keypad allow the input of is commands to the controller PRO and, via the transmit/receive unit RTX and the antenna ANT, to the device GER which includes a corresponding opposite station, not shown here, for radio traffic.

Like the remote control FEB, the device GER also has a transmit/receive unit RTX with an antenna ANT, wherein it is possible for important functions of the transmit/receive unit, such as the transmission power and the receiver sensitivity in particular here, to be influenced both in the remote control FEB via the controller PRO and in the device GER via the controller STE.

For the purposes of the invention, a known radio standard e.g. Bluetooth is used for the wireless communication between remote control FEB and device GER.

In accordance with the invention, at the docking point which is initially used for the energy transfer for charging the accumulator as explained above, it is additionally possible to perform an information transfer which relates to the assignment mode. This information transfer at the docking point can take place in a multiplicity of ways, and several possibilities are explained below.

FIG. 2 shows the possibility for information transfer via the transformer TRA, wherein it is possible both in the remote control FEB and in the device GER to extract signals by means of a filter FIL, which signals can be sent by the controller PRO in the remote control FEB and by a controller STE in the device GER, and vice versa, via the transformer interface TRA.

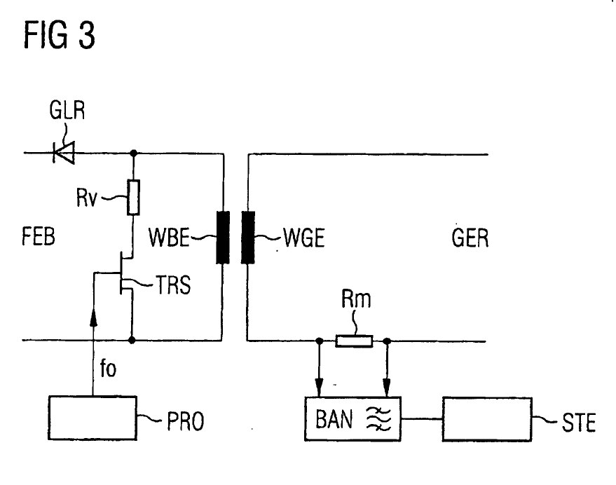

A simple possibility for an information transfer in the sense of “detecting” a remote control is outlined in FIG. 3. The coil WBE of the transformer half in the remote control is bridged by a transistor TRS, possibly in series with a series resistor Rr. The transistor TRS can be activated by the controller PRO of the remote control FEB using a predetermined individual frequency f₀, e.g. 1 kHz, such that the impedance changes significantly accordingly. These periodic changes result in a voltage drop at a measuring resistance Rm on the device side, and a filter BAN which is suited to the individual frequency supplies the resulting signal to the controller STE of the device.

If a remote control FEB is docked onto the device GER, the accumulator AKU can be charged directly. Furthermore, it is only possible to detect that a remote control is present by means of a current or impedance measurement on the device side. In the case of a measurement as per FIG. 3, for example, an identification is also possible. In addition, data such as a code, PIN, etc. can also be exchanged via the transformer interface TRA. However, it is also already possible to initialize a radio mode which, e.g. in the case of Bluetooth, effects an assignment of the radio identification codes for remote control FEB and device GER. In this way, it is possible at the same time to adapt the parameters of the remote control to the type of device which must be operated, or to transfer the operating parameters to the remote control. In order to ensure that the data was fully transferred in the assignment mode, the end and/or progress of the data transfer can be displayed, e.g. by means of an indicator light source ANZ.

The actual operation of the device GER preferably takes place via radio by means of the remote control which is normally held in the hand of an operator, wherein a few input keys TAS on a keyboard are usually adequate. When the remote control is docked, a plurality or even just one of these keys can be used to start the routine of the assignment mode, and therefore no complicated inputs via alphanumeric keypads are required. The exchange of data which is required for the assignment then executes automatically.

Since the assignment takes place at the docking point, the invention provides for transferring the data which is required for this purpose via radio, wherein the radio range must be decreased so far that radio traffic with other units is excluded. An example for an identification and assignment procedure is described for the Bluetooth standard, for example, in: “LMP Lager Tutorial”, 3.1.2 Authentication, 3.1.3 Pairing (freely available on the www at http://203.147.194.107/infotooth/tutorial/lmp.asp). A return to the standard range only takes place after the assignment is complete, such that the remote control can then be used for its purpose accordingly.

The radio range can be decreased very easily by reducing the transmission power, i.e. to a minimal power that is sufficient for a data transfer generally over just a few cm when the remote control FEB is docked. As a result of this, unintentional communication with external devices or “eavesdropping” is hardly possible.

Alternatively, it is also possible to decrease the range by reducing the receiver sensitivity of the device GER, whereby the risk of interference by external devices is decreased. The same applies to a decrease in the range by intervening in the antenna function, wherein a combination of the cited measures can be appropriate in many cases, in particular a reduction of the transmission power on one side and a reduction of the receiver sensitivity on the other. In this case, it should be clear that all measures for restricting the range can be carried out on the remote control side and/or the device side.

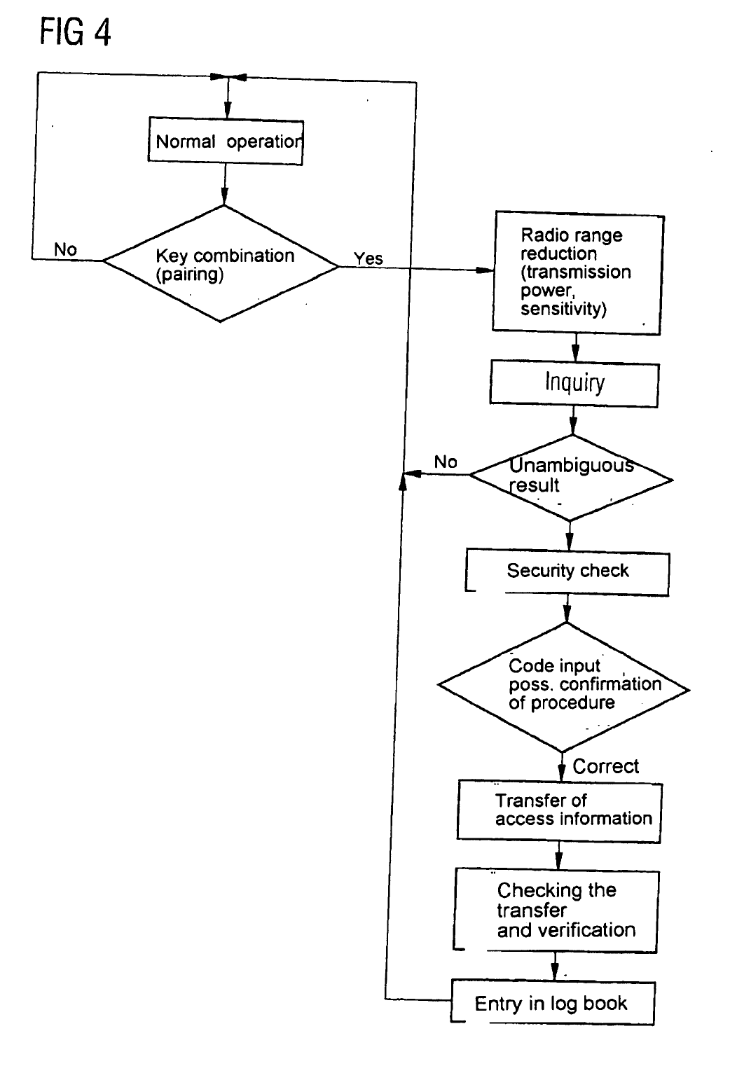

In order to explain a possible initialization routine, reference is made to FIG. 4 in which such a routine is illustrated, starting with the docking. In this routine, following depression of a specific key combination after a remote control has been docked, the radio range is decreased in the next step and the assignment mode is then carried out in a known manner.

A translation key to FIG. 4 is provided after the detailed description regarding FIG. 4.

Of course, part of the information exchange can also take place via the inductive interface TRA, in particular at the beginning or at the end of the overall assignment routine.

It is also worth mentioning that, with its (additional) inductive interface, the docking point offers the possibility of e.g. a notebook or other service device being connected by a service technician. A cable connected to the service device can have e.g. an “adhesive head” which, like the remote control, contains the complementary half of the transformer TRA.

Key to FIG. 4

| | |
|---|---|
| Normalbetrieb | Normal operation |
| Nein | No |
| Tastenkombination (Pairing) | Key combination (pairing) |
| Ja | Yes |
| Funkreichweitenreduktion | Radio range reduction |
| (Sendeleistung, | (transmission power, |
| Empfindlichkeit) | sensitivity) |
| Inquiry | Inquiry |
| Nein | No |
| Eindeutiges Ergebnis | Unambiguous result |
| Sicherheitsabfrage | Security check |
| Codeeingabe | Code input |
| ev. Bestätigung des Vorgangs | poss. confirmation of procedure |
| Richtig | Correct |
| Übertragung der | Transfer of |
| Zugangsinformation | access information |
| Überprüfung der | Checking the |
| Übertragung und | transfer and |
| Verifikation | verification |
| Logbuchvermerk | Entry in log book |

1-4. (canceled)

5. A radio remote control for issuing commands to a remotely controllable device in a wireless manner, comprising:
a transmit/receive unit;
a controller;
an acoustic or optic indicator, and
at least one antenna, wherein
the radio remote control is configured to:
execute an assignment mode before becoming operational,
decrease upon triggering the assignment mode by a user a radio range of the remote control so far that communication is only possible with a device which is immediately adjacent to the remote control, and
return to a standard radio range after an assignment has successfully been completed using the assignment mode, wherein the indicator is configured to indicate acoustically or optically a start or a completion of the assignment mode.

6. The radio remote control according to claim 5, wherein the radio range is decreased by reducing a transmission power of the radio remote control.

7. The radio remote control according to claim 5, wherein the radio range is decreased by reducing a receiving sensitivity of the transmit/receive unit.

8. The radio remote control according to claim 5, wherein the radio range is decreased by adjusting a function of the antenna.
